(19) United States
(12) Patent Application Publication
(10) Pub. No.: US 2005/0120351 A1
(43) Pub. Date: Jun. 2, 2005

(54) System and method for a synchronized shared buffer architecture for multimedia players

(76) Inventor: Jeremy S. de Bonet, North Andover, MA (US)

Correspondence Address: SPRINKLE IP LAW GROUP, 1301 W. 25TH STREET, SUITE 408, AUSTIN, TX, 78705, US

(21) Appl. No.: 10/975,297

(22) Filed: Oct. 28, 2004

Related U.S. Application Data
(60) Provisional application No. 60/516,479, filed on Oct. 31, 2003.

(51) Int. Cl. G06F 9/00

(52) U.S. Cl. 718/107

(57) ABSTRACT

Systems and methods for architectures for a compact and efficient multimedia player are disclosed. These architectures may increase the robustness of a multimedia player with respect to network fluctuations by compensating for the fluctuations of bandwidth in a network using at least two program threads, a network or reader thread and a rendering thread. Synchronization between the reader thread and rendering thread may be accomplished through a shared buffer into which data blocks received by the reader thread are written, and from which data blocks are retrieved and rendered by the rendering thread. This shared buffer, in turn, may be an array of individual buffers which are continually refilled and reused during execution of the multimedia player.

### RELATED APPLICATIONS

This application claims a benefit of priority under 35 U.S.C. § 4119 to the filing date of, U.S. Provisional Patent Application Ser. No. 60/516,479 by inventor Jeremy S. de Bonet, entitled “System and Method For Synchronized Shared Ring Buffer Architecture For Streaming Multimedia Players” filed on Oct. 31, 2003, the entire contents of which are hereby expressly incorporated by reference for all purposes.

This application is related to, U.S. patent application Ser. No. 10/342,113 by inventors Jeremy S. de Bonet and Todd Stiers, entitled “Network Proxy Platform that Simultaneously Supports Data Transformation, Storage, and Manipulation for Multiple Protocols” filed on Jan. 14, 2003; Ser. No. 10/347,138 by inventor Jeremy S. de Bonet, entitled “Method for Isolating and Protecting Software Components to Increase Reliability and Prevent Inadvertent Corruption” filed on Jan. 17, 2003; Ser. No. 10/345,101 by inventors Jeremy S. de Bonet, Todd Stiers and Jeffrey R. Annison entitled “Method and System of Accessing Shared Resources Using Configurable Management Information” filed on Jan. 15, 2003; Ser. No. 10/345,067 by inventors Jeremy S. de Bonet entitled “Method and System of Protecting Shared Resources Across Multiple Threads” filed on Jan. 15, 2003; Ser. No. 10/664,246 by inventors Jeremy S. de Bonet, Todd Stiers, Phillip Alvelda and Jeffrey R. Annison entitled “System and Method for the Packaging and Distribution of Data” filed on Sep. 17, 2003; __/______ by inventor Jeremy S. de Bonet and Hanqing Liao, entitled “System and Method for a Data Format for Command Encapsulation” filed on Oct. 28, 2004 (ATTY. DOCKET NUMBER IDET1130-1) and __/______ by inventor Jeremy S. de Bonet, entitled “System and Method for a Symmetric Architecture for Multimedia Players” filed on Oct. 28, 2004 (ATTY. DOCKET NUMBER IDET1140-1); the entire contents of which are hereby expressly incorporated by reference for all purposes.

### TECHNICAL FIELD OF THE INVENTION

The invention relates in general to multimedia players, and more particularly, to methods and systems for compact and efficient architectures for streaming multimedia players.

### BACKGROUND OF THE INVENTION

The use of computer networks to store data and provide information to users is increasingly common. A microcosm of this phenomenon can be seen in the prevalence of the internet. The internet is used to distribute a wide variety of content to users, including video, audio, text, images etc. Each of these types of content may, in turn, be distributed in a wide variety of formats. These various types of content may be themselves packaged in a variety of payload formats and delivered via a whole host of application and transmission protocols.

In most cases, a user at a client computer wishes to access a certain piece of data and makes a request to a server computer for that piece of data. The server computer encapsulates the requested data in a set of packages for delivery to the client computer. The encapsulation methodology used by the server depends on the variables mentioned above, the type of content, the format of that content, the format of the payload, the application and transmission protocols being used to send the data etc. Upon receiving a package, the client computer must peel back the layers of the raw data received to ascertain the content and payload format used to package the data so the data may be processed and rendered correctly.

In most cases, the tasks of deciphering, decoding, and rendering the received data falls to a multimedia player residing on the client computer, such as Microsoft Media Player, RealPlayer or Quick Time. Typically, these multimedia players receive data over the network, store this data to a buffer, and render data from this buffer.

In most cases, the type of buffer utilized is a ring buffer with a read and write pointer. The multimedia player receives data and writes this data to the location pointed to by the write pointer. Similarly, the multimedia player reads data from the location indicated by the read pointer and renders this data. Occasionally, however, the read and write pointer may point to the same location. This situation indicates that the buffer is full and no more data can be written to the buffer without overwriting previously stored data. Conversely, this situation may also indicate that the buffer is empty and no more data can be read from the buffer. In either of these cases, the multimedia player must block until either data is written to the buffer or read from the buffer. Not only does this slow the execution and operation of the multimedia player but, additionally, to synchronize read and write operations to the buffer and to check and maintain separate read and write pointers, requires a significant amount of overhead.

When performing these tasks on a workstation or desktop environment, these issues are not so problematic. Most workstations or desktop computers have fast enough processors and large enough memories to accommodate the multimedia players with little difficulty. In a mobile environment, however, these issues may become problematic. Cellular telephones, PDAs, mobile computers etc. simply do not have the processing power or space to be able to efficiently evaluate and render raw multimedia data using conventional multimedia players.

Despite the limited ability of these mobile devices, their users still desire the ability to receive and display multimedia content. In fact, the increasing prevalence of these types of mobile devices has only increased the demand for multimedia data in a mobile environment.

Typically, to distribute multimedia data to mobile devices some reduction in the data rate is utilized to make the transfer, decoding and rendering of the multimedia data more efficient. This may be achieved by distributing the requested multimedia in a lower fidelity, or at a lower sampling rate. This is a non optimum solution however, a wireless device in one area may have a certain bandwidth while another device may have a much lower bandwidth (e.g. in a tunnel, or area of low reception), and the bandwidth of each device on a network may vary dynamically. These variations in bandwidth can cause the multimedia player on the mobile device to block frequently, as the buffer utilized by the multimedia player alternately fills when the bandwidth is relatively high and empties when the bandwidth is relatively low.

Thus, a need exists for a compact and efficient architecture for a multimedia player which can synchronize the writing and rendering operations of the multimedia player and compensate for fluctuations in bandwidth.

### SUMMARY OF THE INVENTION

Systems and methods for architectures for a compact and efficient multimedia player are disclosed. These architectures may increase the robustness of a multimedia player with respect to network fluctuations; during periods of low bandwidth, network blackout or congestion, rendering can continue using data which has been downloaded into the shared buffer. Conversely, if bandwidth is high data may be downloaded faster than it can be rendered and stored to available space in the shared buffer. These architectures are capable of providing synchronization between the reading and rendering operations of the multimedia player and compensating for the fluctuations of bandwidth in a network using at least two program threads, a network or reader thread and a rendering thread. The activities of these two threads may be synchronized through a shared buffer into which data blocks received from the network by the reader thread are written and from which data blocks are retrieved and rendered by the rendering thread. This shared buffer, in turn, may be an array of individual buffers which are continually refilled and reused during execution of the multimedia player.

In one embodiment, a first thread is operable to read data into a buffer, a second thread is operable to render data from the buffer and the first thread and second thread are synchronized so that the first thread blocks if the buffer is full and the second thread blocks if the buffer is empty.

In one embodiment, the buffer comprises a set of elements.

In one embodiment, the buffer comprises two elements.

In one embodiment, each element is one byte.

In one embodiment, the data is a packet and each element is larger than the packet.

In one embodiment, the buffer is operable to synchronize the first thread and the second thread.

In one embodiment, the buffer maintains a read pointer and a write pointer, the read pointer operable to point to an element in the set of elements and the write pointer operable to point to an element within the set of elements.

In one embodiment, the first thread blocks if the read pointer and write pointer point to the same element before the read operation.

In one embodiment, the second thread blocks if the write pointer and read pointer point to the same element before the render operation.

In one embodiment, the first thread and second thread are synchronized with a mutex.

In one embodiment, the first thread and second thread are synchronized with a Java “synchronized” function call.

In one embodiment, the first thread and second thread are synchronized with a semaphore.

These, and other, aspects of the invention will be better appreciated and understood when considered in conjunction with the following description and the accompanying drawings. The following description, while indicating various embodiments of the invention and numerous specific details thereof, is given by way of illustration and not of limitation. Many substitutions, modifications, additions or rearrangements may be made within the scope of the invention, and the invention includes all such substitutions, modifications, additions or rearrangements.

### BRIEF DESCRIPTION OF THE DRAWINGS

The drawings accompanying and forming part of this specification are included to depict certain aspects of the invention. A clearer impression of the invention, and of the components and operation of systems provided with the invention, will become more readily apparent by referring to the exemplary, and therefore nonlimiting, embodiments illustrated in the drawings, wherein identical reference numerals designate the same components. Note that the features illustrated in the drawings are not necessarily drawn to scale.

FIG. 1 is a block diagram of an exemplary system for use with embodiments of the present invention.

FIG. 2 is a flow diagram depicting the delivery of content from a content source to an intended recipient.

FIG. 3 is a depiction of an embodiment of an architecture for the synchronization of the network and rendering components of a multimedia player.

FIG. 4 is a depiction of another embodiment of an architecture for the synchronization of the network and rendering components of a multimedia player.

FIG. 5 is a depiction of the behavior of the architecture depicted in FIG. 4 in one set of circumstances.

FIG. 6 is a depiction of the behavior of the architecture depicted in FIG. 4 in another set of circumstances.

### DESCRIPTION OF PREFERRED EMBODIMENTS

The invention and the various features and advantageous details thereof are explained more fully with reference to the nonlimiting embodiments that are illustrated in the accompanying drawings and detailed in the following description. Descriptions of well known starting materials, processing techniques, components and equipment are omitted so as not to unnecessarily obscure the invention in detail. It should be understood, however, that the detailed description and the specific examples, while indicating preferred embodiments of the invention, are given by way of illustration only and not by way of limitation. Various substitutions, modifications, additions and/or rearrangements within the spirit and/or scope of the underlying inventive concept will become apparent to those skilled in the art from this disclosure.

A few terms are defined or clarified to aid in understanding the descriptions that follow: a device may be any sort of apparatus which can receive and display data including mobile phones, PDAs, laptop computers and the like.

A format is a way of arranging, organizing, or representing data, usually using a defined standard such as MPEG or motion JPEG. For purposes of this application, formats will be understood to be distinct if characteristics of the represented data differ in any manner. Additionally the same standard at two different rates will be understood to mean two distinct formats. For example, high framerate motion JPEG would be a distinct format from low framerate motion JPEG. Furthermore, augmenting a defined standard with additional information will be understood to constitute a distinct format. For example, augmenting an MPEG representation of video data with closed captioning information would be a distinct format from video data represented in the MPEG format alone. Compressed video data will also be understood as distinct from its uncompressed equivalent. For example, video data compressed with MPEG will be understood as distinct format from identical uncompressed raw video data. It will be obvious to those of ordinary skill in the art that for purposes of this application distinct formats may be created in an almost endless variety of ways, such as varying resolution, screen size, sampling rate, and the like.

A read is intended to encompass any or all portions of the acts of requesting data, receiving data, storing data or any administrative actions associated with the acts of requesting, receiving or storing, such as obtaining and releasing locks on mutexes, waiting to obtain access to buffers etc.

A render is intended to encompass any or all portions of the acts of reading data from a storage location, processing the data, and outputting the results of the processing including any administrative actions associated with the acts of reading, processing or outputting, such as obtaining and releasing locks on mutexes, waiting to obtain access to buffers etc.

The term buffer will be used inclusively to refer to a storage location, set of storage locations, logic associated with a storage location or set of locations, such as functions intended to return storage locations, control access to storage locations etc., or any subset thereof.

A packet is intended to mean any set of data, including a set of data operable or configured for transmission.

Though the exemplary embodiment described below utilizes embodiments of the present invention in a media bridge designed to convert broadcast media such as television into a variety of formats for delivery over a wireless communication network, those skilled in the art will appreciate that these same systems and methods may be employed for a myriad number of other uses and applications, such as delivering internet content over a wireline system, or other type of network topology. Additionally, it will be understood that these same systems and methods, or any subset, can be implemented in a variety of software systems, computer programs, hardware, and any combination thereof.

Attention is now directed to systems and methods for architectures for a compact and efficient multimedia player. These architectures are capable of providing synchronization between the reading and rendering operations of a multimedia player and compensating for the fluctuations of bandwidth in a network using at least two program threads, a network or reader thread and a rendering thread. The activities of these two threads may be synchronized through a shared buffer into which data blocks received from the network by the reader thread are written and from which data blocks are retrieved and rendered by the rendering thread. This shared buffer, in turn, may be an array of individual buffers which are continually refilled and reused during execution of the multimedia player. Each of these individual buffers may itself be larger than any data block received over the network, allowing each data block to be placed in one individual buffer.

This architecture may increase the robustness of a multimedia player with respect to network fluctuations; during periods of low bandwidth, network blackout or congestion, the rendering thread can continue rendering, using data which has been downloaded into the shared buffer. Conversely, if bandwidth is high the reader thread may download data faster than it can be rendered and store the data to available space in the shared buffer. By taking advantage of excess bandwidth and compensating for bandwidth shortages, the peaks and valleys of available bandwidth experienced by a mobile device may be smoothed, allowing a multimedia player to render data at a higher bit rate.

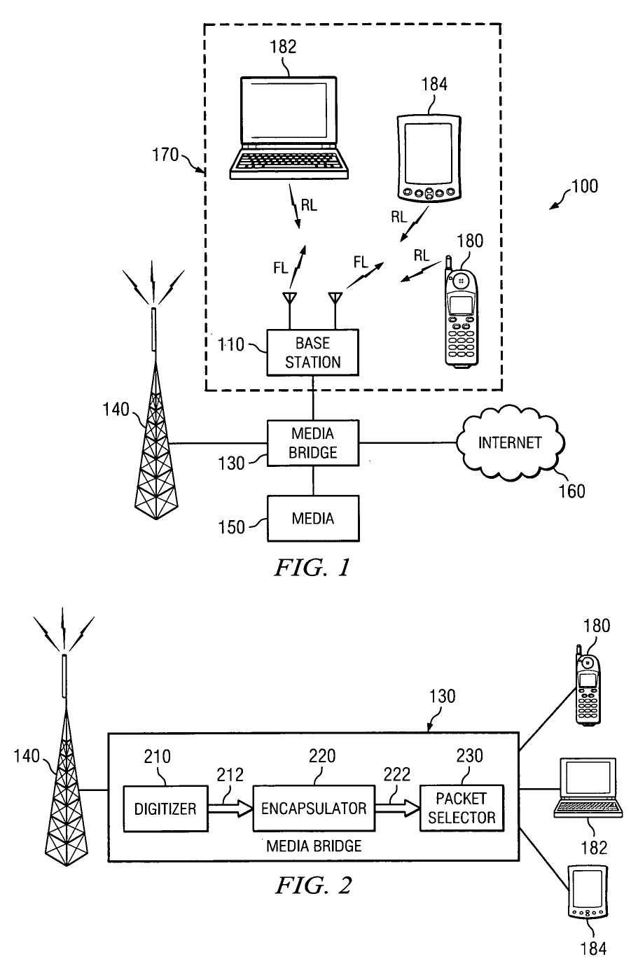

Turning now to FIG. 1, a diagram illustrating the structure of an exemplary communications system for utilization with embodiments of the present invention is shown. As depicted in this figure, this system 100 comprises a media bridge 130 for interfacing between different types of content systems 140, 150, 160 and one or more wireless (or potentially wireline) communication networks 170. Content systems 140, 150, 160 may be broadcast media such as television or radio, other audio or video data, such as a video feed from a DVD player, or the Internet.

Wireless communication network 170 is in turn composed of base station 110 that is configured to communicate with a plurality of mobile devices (devices) 180, 182, 184. Mobile devices 180, 182, 184 may, for example, be cellular telephones, laptop computers, personal information managers (PIMs or PDA), or the like that are configured for wireless communication. These devices 180, 182, 184 may be running software designed for use with embodiments of the present invention. It should be noted that these devices 180, 182, 184 need not actually be “mobile,” but may simply communicate with base station 110 via a wireline or wireless link. Base station 110 transmits data to mobile devices 180, 182, 184 via corresponding forward link (FL) channels, while mobile devices 180, 182, 184 transmit data to base station 110 via corresponding reverse link (RL) channels.

Users of mobile devices 180, 182, 184 may wish to have content from content sources 140, 150, 160 delivered to them. This may be problematic, however, as delivery of much of this content typically requires large amounts of data to be delivered over a high-reliability high-bandwidth connection. Additionally, even if wireless network 170 is such a high-bandwidth network, mobile devices 180, 182, 184 may experience temporary periods of low-bandwidth connection to base station 110, or may be incapable of handling the complexity of such content. Media bridge 130 alleviates these problems by delivering tailored content from content source 140, 150, 160 to each individual mobile device 180, 182, 184.

Media bridge 130 may encapsulate content from content sources 140, 150, 160 for delivery to mobile devices 180, 182, 184 in a data format which is compact, and simplifies the tasks of decoding and rendering the data format performed by mobile devices 180, 182, 184. Streaming content from a content source 140, 150, 160 is fed into media bridge 130, at which point media bridge 130 may capture and digitize the incoming content if the data is not already in a digital format. This digitized data may be divided up into serialized portions and converted to a wide variety of formats. This data can then be encapsulated in packets with a certain data format and a particular series of packets may be sent to base station 110 for delivery to mobile device 180, 182, 184 depending on criteria associated with that particular device 180, 182, 184. It should be noted that the mobile devices 180, 182, 184 and system components in this figure are exemplary and other systems may comprise other types and other combinations of devices.

Embodiments of the steps involved in the distribution of data by media bridge 130 are depicted in more detail in FIG. 2. Content coming from media source 140 which is to be delivered to a device 180 may be in an analog format. This analog content, such as a television signal, radio broadcasts or video game data, may be captured using automatic or manual capture methods, and converted to a digital signal (STEP 210). One of ordinary skill in the art will understand the many and varied ways to accomplish this capture and analog to digital conversion (STEP 210). In one embodiment, raw TV signal 140 may be connected to a TV tuner capture card, which in turn captures incoming analog TV signal 140. This analog signal 140 may be converted to a digital signal via the use of a standard analog to digital converter of the type that are well known in the art.

The resulting digital data 212 may be converted to a variety of formats and encapsulated in packets (STEP 220) in order to facilitate delivery of data 212 to device 180. Packets of this data 222 may then be selected for delivery (STEP 230) to device 180 based upon a set of criteria.

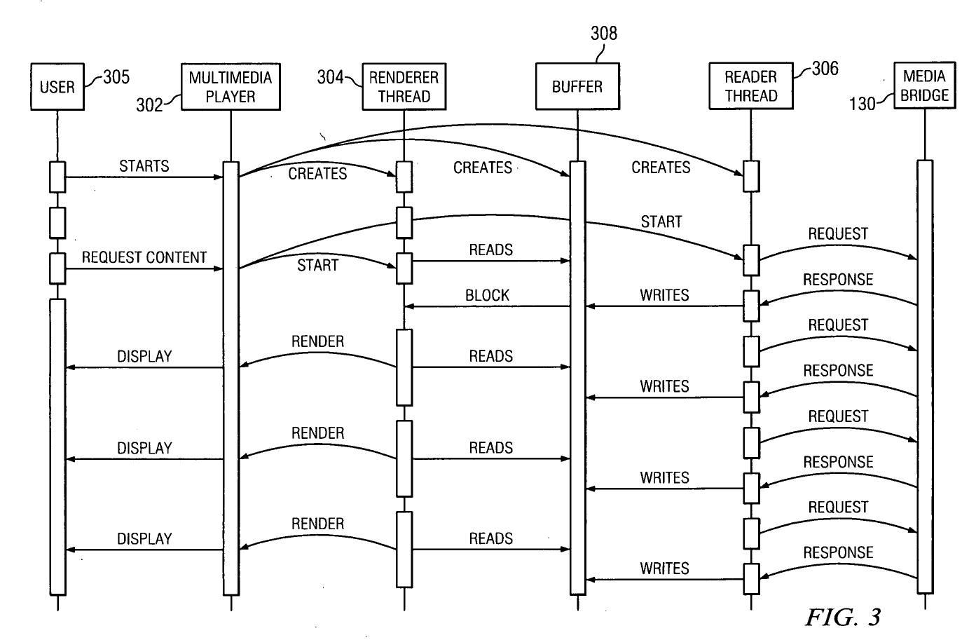

Moving now to FIG. 3, one embodiment of an architecture for requesting, receiving and displaying multimedia content at a mobile device is depicted. A user 305 at mobile device 180 may wish to receive or play some form of multimedia content, and open multimedia player 302. Multimedia player 302 may in turn instantiate renderer thread 304, reader thread 306 and buffer 308.

Reader thread 306 is responsible for requesting packets over network 170 from media bridge 130 and storing them in buffer 308, while renderer thread 304 is responsible for taking packets stored in buffer 308 and rendering them for presentation to user 305 of mobile device 180. In one embodiment, one or more of these threads need not be a new thread, but could be executed in the thread used by multimedia player 302.

Continuing with the example depicted in FIG. 3, reader thread 306 makes a request for data from media bridge 130. Media bridge 130 responds by delivering a packet to reader thread 306, which writes this packet into buffer 308. Renderer thread 304 can the read this packet from buffer 308 and render the contents of the packet for presentation to user 305 on mobile device 180. Reader thread can then make another request for a packet from media bridge 130; media bridge 130 delivers another packet to reader 306 which writes this packet into buffer 308. Renderer thread 304 can then read this second packet from buffer 308 and render the contents of this packet for user 305 of mobile device 180. This process may continue until the entirety of the requested content has been delivered and rendered. In this manner, content from media server 130 may be requested by mobile device 180, received by this device 180, and displayed to user 305 of device 180.

The example described with respect to FIG. 3, however is an ideal situation, with reader thread 306 and renderer thread 304 operating in perfect synchronicity; for every packet requested from media bridge 130 and written into buffer 308 by reader thread 306, one packet is read out of buffer 308 and rendered by renderer thread 304. Thus, buffer 308 is never fully filled or fully emptied.

Under real world conditions, however, this situation almost never occurs. Network conditions and processor demands conspire to create varying abilities to render data from buffer 308 or to receive data from media server 130. For example, suppose mobile device 130 is in area with a high-bandwidth connection to media server 130, thus reader thread 306 may be capable of downloading packets from media bridge 130 at a high rate. Now suppose, however, that there is a high demand on mobile device 180, consequently it is difficult for renderer thread 304 to obtain processor time for the rendering of packets from buffer 308.

In this situation, reader thread 306 may download packets from media bridge 130 and write them to buffer 308 more quickly than renderer thread 304 can read them from buffer 308 and render them. If this situation persists, buffer 308 may fill up with data unread by renderer thread 304. Eventually, reader thread 306 may begin to overwrite locations in buffer 308 which contain packets that have not been read and rendered by renderer thread 304. This may cause gaps in the content being presented to a user of mobile device 180, and may even cause the remainder of the content to become unrenderable or multimedia player to crash.

Conversely, the opposite situation may also occur. Mobile device 180 may be in area with a low-bandwidth connection to media bridge 130, while there is low demand on mobile device 180. Therefore, reader thread 306 may only be capable of downloading packets from media server 130 at a low rate, while renderer thread 304 may able to process these packets very quickly. Here, buffer 308 may be emptied by renderer thread 304 more quickly than it can be filled by reader thread 306. Eventually, renderer thread 306 may empty buffer 308 and begin to read from locations in buffer 308 which contain garbage data, with similar results to those described above.

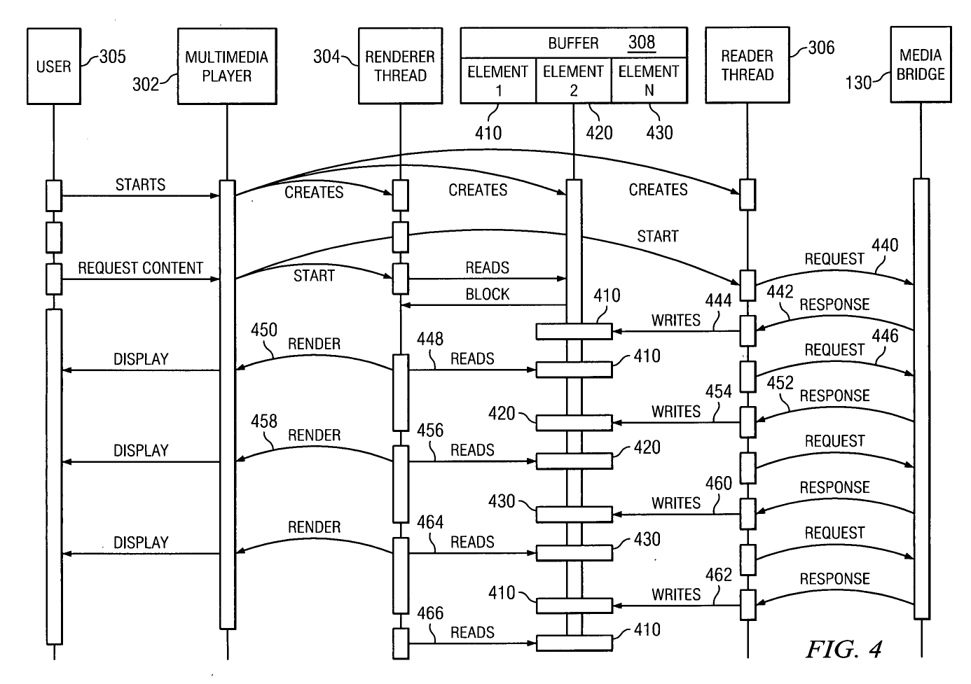

Turning now to FIG. 4, one embodiment of an architecture for requesting, receiving and displaying multimedia content at a mobile device which compensates for these fluctuations in network bandwidth and processing power is depicted. Again, user 305 at mobile device 180 may wish to receive or play some form of multimedia content and open multimedia player 302. Multimedia player 302 may in turn instantiate renderer thread 304, reader thread 306 and buffer 308.

Buffer 308 may be shared by, and accessible to, both reader thread 306 and renderer thread 304 and operable to synchronize the activities of renderer thread 304 and reader thread 306. Buffer 308 may comprise a set of elements. For example, buffer 308 may have two elements. In this case, both elements may be used simultaneously; one element being filled with data from the network by reader thread 306, while data from the other element is rendered by renderer thread 304. Each of these elements may be of an arbitrary size, usually determined when multimedia player 302 instantiates buffer 308. For example, each element may be a set of one-byte buffers, causing buffer 308 to act essentially like a pipe, or queue, as is known in the art.

In one embodiment, buffer 308 comprises an array and associated logic; each element 410, 420, 430 in the array of buffer 308 is itself a buffer of a greater size than any packet which may be received by reader thread 306. These elements, 410, 420, 430 will be continually filled, and then refilled and reused, akin to a ring buffer as is known in the art. Buffer 308 may behave to smooth the fluctuations in bandwidth of network 170 by blocking render thread 304 if renderer thread 304 attempts to read from buffer 308 and buffer 308 is empty, similarly if buffer 308 is full, buffer 308 will block reader thread 306 from writing to buffer 308 until data is read from buffer 308.

This thread synchronization may be accomplished using read and write pointer in association with the array of elements 410, 420, 430 comprising buffer 308, and a thread synchronization mechanism such as a pair of mutexes, a Java “synchronized” function call, a semaphore, busy waiting etc. Renderer thread 304 may block if the read pointer points to the same element as the write pointer before data is read from buffer 308, while reader thread 306 may block if the write pointer points to the same buffer as the read pointer before data is written to buffer 308. In one particular embodiment, buffer 308 may be instantiated from a class by multimedia player 302, as is known in the art. One specific embodiment for a buffer class of this type is depicted in Appendix A.

Reader thread 306 is responsible for requesting packets over network 170 from media bridge 130 and storing them in buffer 308, while renderer thread 304 is responsible for taking packets stored in buffer 308 and rendering them for presentation to the user of mobile device 180. To gain access to buffer 308, reader thread 306 and renderer thread may call functions provided by buffer 308. For example, if buffer 308 is instantiated from the class depicted in Appendix A, reader thread 306 and renderer thread 304 may be expressed in pseudocode as follows:

```
// globally shared RingOfBuffers
  RingOfBuffers m_rob;
  void NetworkReaderThread( ) {
    while(1){
      ByteVector vy;
      vy=m_rob.GetWriteBuffer( );
      ReadFromNetwork(vy);
    }
  }
  void ScreenRendererThread( ) {
    while(1){
      ByteVector vy;
      vy=m_rob.GetReadBuffer( );
      RenderToScreen(vy);
    }
  }
```

In one embodiment, the calls GetWriteBuffer( ) and Get ReadBuffer( ) may be used to access buffer 308, and may potentially block if buffer 308 is full.

Once buffer 308, reader thread 306, and renderer thread 304 have been instantiated by multimedia player 302, reader thread 306 may send requests for content to media bridge 130, and may receive a packet containing content in return. Each of the packets from media server 130 may then be placed in one of elements 410, 420, 430. Renderer thread 304 may read packets from elements 410, 420, 430 of buffer 308 and render them for display to user.

In FIG. 4, for example, initially, render thread 304 may block trying to read buffer 308, as buffer 308 is empty. Reader thread then sends a request (request 440) to media server 130 and receives (response 442) a packet containing a portion of content which is placed (write 444) in element 410, and then send another request (request 446) for content to media server 130. As soon as a packet is placed in element 410, render thread 304 unblocks and reads (read 448) the packet from element 410, rendering this packet for user 305 (render 450). When another packet is received by reader thread 306 (response 452) it is placed in element 420 (write 454) from whence it is read by reader thread 304 (read 456) to be rendered by render thread 304 (render 458). Reader thread continues to place packets received from media server 130 into elements 410, 420, 430, (write 460, 462) until an entire piece of content is received from media server 130. When the last element 430 of buffer 308 is filled, reader thread may start writing data into first element 410 of buffer 308 once again. Simultaneously, render thread 304 continues reading packets from elements 410, 420, 430 (read 464, 466) until an entire piece of content has been rendered for user. When renderer thread 304 has read from the last element 430 of buffer 308, it may start reading from the first element 410 again, as is known in the art.

It will be apparent to those of skill in the art, that reader thread 306 and renderer thread 304 may be executing independently of one another, and that their respective tasks may be performed without regard to the execution of the other thread. It will also be apparent the benefits which accrue when utilizing the above architecture. For example, because the architecture described increases the duration over which the average rate of downloading data needs to match (or exceed) the average data rate needed for continuous reading, the architecture may increase the ability of device 180 to coordinate delivery of data with media bridge 130. In certain embodiments, multimedia player 302 may communicate its current bandwidth estimate and buffer 308 status to media bridge 130 by appending information, which describes the current space available in buffer 308 as well as bandwidth estimates calculated over a set of downloads, to one or more requests (440, 446 etc.) for data. Media bridge 130 may then tailor its responses (442, 452 etc.) according to this information.

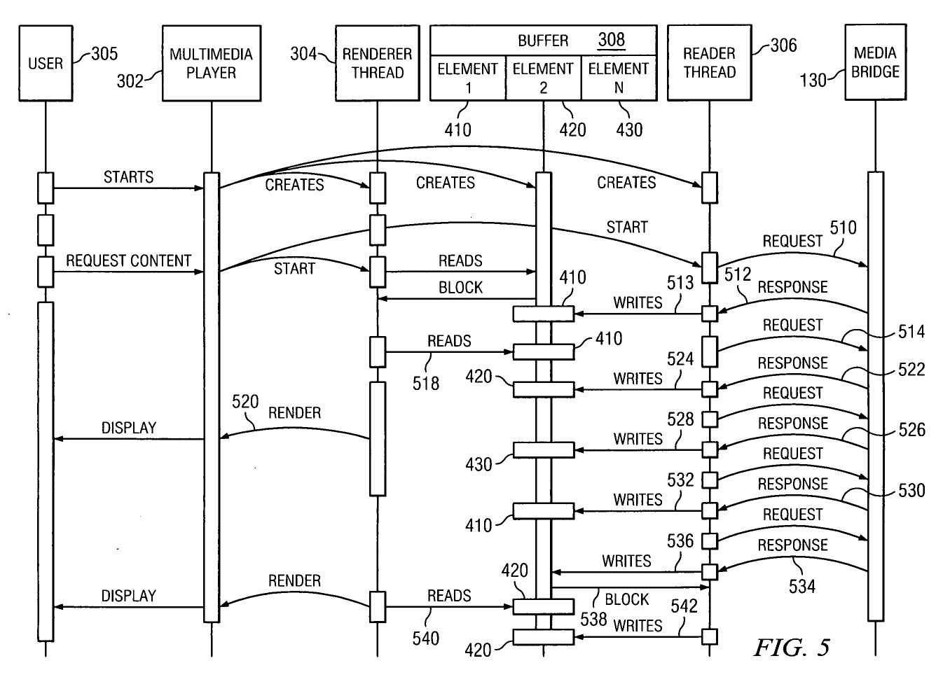

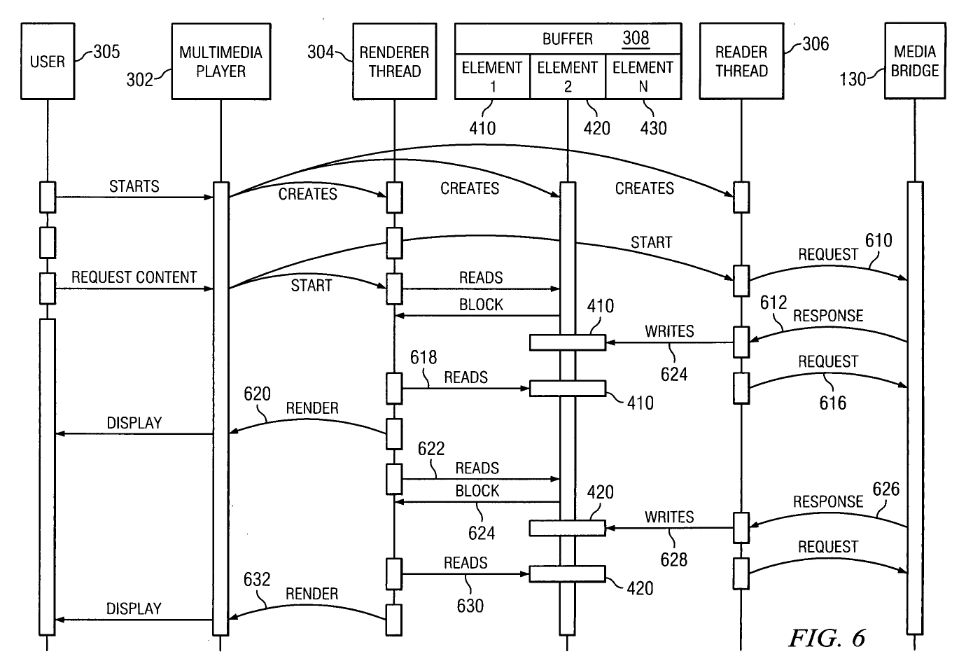

As explained above, certain conditions may cause buffer 308 to fill or empty during operation of multimedia player 302. FIG. 5 depicts the behavior of the architecture depicted in FIG. 4 under certain high-bandwidth conditions. Once again, user 305 at mobile device 180 may wish to receive or play some form of multimedia content and open multimedia player 302. Multimedia player 302 may in turn instantiate renderer thread 304, reader thread 306 and buffer 308.

Initially, render thread 304 may block trying to read buffer 308, as buffer 308 is empty. Reader thread then sends a request (request 510) to media server 130 and receives a packet (response 512) which is placed in element 410 (write 513), and then sends another request (request 514) for content to media server 130. As soon as a packet is placed (write 513) in element 410, render thread 304 unblocks and reads (read 518) the packet from element 410, rendering this packet (render 520) for user 305. Suppose, however, that mobile device 180 has a high-bandwidth signal. Reader thread 306 receives another packet (response 522) which it places into element 420 (write 524), eventually receiving a packet (response 526) which it places into the last element 430 (write 528). Reader thread 306 then receives another packet (response 530) which it places in first element 410 (write 532). Meanwhile, render thread 304 is still rendering the packet it initially read from element 410 (render 520).

Upon receiving yet another packet (response 534), reader thread 306 attempts to write this packet to buffer 308 (write 536). Writing this packet to buffer 308, however, would overwrite a packet in elements 410, 420, 430 which has not yet been read by reader thread 304. Consequently, buffer 308 may not allow reader thread 306 from accessing buffer 308, causing reader thread 306 to block (block 538). At some point in the future, renderer thread 304 may finish rendering the initial packet and read a second packet from element 420 of buffer 308 (read 540) for rendering. At this point, buffer 308 may allow reader thread 306 access to buffer 308 and reader thread 306 may unblock and write the received packet to element 420 (write 542). By restricting access to buffer 308, the activities of reader thread 306 and render thread 304 can be synchronized so packets in buffer 308 which have not yet been read and rendered by renderer thread 304 will not be overwritten.

FIG. 6 depicts the behavior of the architecture depicted in FIG. 4 in the opposite situation, when the connection between mobile device 180 and media server 130 is a low bandwidth one. Initially, render thread 304 may block trying to read buffer 308, as buffer 308 is empty. Reader thread then sends a request (request 610) to media server 130 and receives a packet (response 612) which is placed in element 410 (write 614), and then sends another request (request 616) for content to media server 130. As soon as a packet is placed (write 614) in element 410 renderer thread 304 unblocks and reads the packet from element 410 (read 618), rendering this packet for user 305 (render 620). Renderer thread 304 may then attempt to read the next element 420 of buffer 308 (read 622). Suppose, however, that mobile device 180 has a low-bandwidth signal and reader thread 306 has not yet received a response from media server 130 to its request (request 616). Consequently, all elements 410, 420, 430 of buffer 308 contain either garbage, or have already been read and rendered by renderer thread 304. In this situation, buffer 308 may not allow renderer thread 304 access to buffer 308, causing renderer thread 304 to block (block 624). At some point in the future, reader thread 306 may receive a packet from media bridge 130 (response 626) and write this packet to element 420 of buffer 308 (write 628). At this point, buffer 308 may allow reader thread 304 access and reader thread 304 may unblock, read the packet from element 420 (read 630) and render this packet for user 305 of mobile device 180 (render 632). By restricting access to buffer 308, the activities of reader thread 306 and render thread 304 can be synchronized so empty elements 410, 420, 430 will not be read or rendered by renderer thread 304.

In the foregoing specification, the invention has been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of invention.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component of any or all the claims.

APPENDIX A
A Java class, used in one embodiment to implement a buffer and
associated logic is given below.

```
import javax.microedition.midlet.*;
  /**
  *
  * @author jsd
  * @version
  */
  public class RingofBuffer {
    private ByteVector [ ] m_vvy;
    private int m_c;
    private int m_nRead;
    private int m_nWrite;
    Integer m_mutexNotFull;
    Integer m_mutexNotEmpty;
    public RingBuffer(int c){
      m_c=c;
      m_nWrite=0;
      m_nRead=0;
      m_vvy=new ByteVector [c];
      m_mutexNotEmpty=new Integer;
      m_mutexNotFull=new Integer;
    }
    public int CYReadable( ) {
      int n;
      int c=0;
      for (n=m_nRead; n!=m_nWrite; n++){
      c=c+m_vvy[n].CYReadable( )
      }
    }
    public ByteVector GetWriteBuffer( ){
      synchronized(m_mutexNotFull){
        if (
          (m_nRead != m_nWrite)
          && ((m_nRead%m_c) == (m_nWrite%m_c))
        ){
          m_mutexNotFull.wait( );
        }
      }
      return m_vvy[m_nWrite%m_c];
    }
    public ByteVector CommitWrite( ){
      m_nWrite++;
      m_mutexNotEmpty.notify( );
    }
    public ByteVector GetReadBuffer( ){
      synchronized(m_mutexNotEmpty){
        if (m_nRead == m_nWrite){
          m_mutexNotEmpty.wait( );
        }
      }
      return m_vvy[m_nRead%m_c];
    }
    public ByteVector CommitRead( ){
      m_nRead++;
      m_mutexNotFull.notify( );
    }
  }
```

1. A method for receiving and processing data, comprising:
providing a first thread operable to read data into a buffer;
providing a second thread operable to render data from the buffer; and
synchronizing the first thread and second thread so that the first thread blocks if the buffer is full and the second thread blocks if the buffer is empty.

2. The method of claim 1, wherein the buffer comprises a set of elements.

3. The method of claim 2, wherein the buffer comprises two elements.

4. The method of claim 2, wherein each element is one byte.

5. The method of claim 2, wherein the data is a packet and each element is larger than the data.

6. The method of claim 2, wherein the buffer is operable to synchronize the first thread and the second thread.

7. The method of claim 6, wherein the buffer maintains a read pointer and a write pointer, the read pointer operable to point to an element in the set of elements and the write pointer operable to point to an element within the set of elements.

8. The method of claim 7, wherein the first thread blocks if the read pointer and write pointer point to the same element before the read operation.

9. The method of claim 8, wherein the second thread blocks if the write pointer and read pointer point to the same element before the render operation.

10. The method of claim 9, wherein the first thread and second thread are synchronized with a mutex.

11. The method of claim 9, wherein the first thread and second thread are synchronized with a Java “synchronized” function call.

12. The method of claim 9, wherein the first thread and second thread are synchronized with a semaphore.

13. A computer readable medium, having instructions embodied thereon for receiving and processing data, the instructions translatable for:
providing a first thread operable to read data into a buffer;
providing a second thread operable to render data from the buffer; and
synchronizing the first thread and second thread so that the first thread blocks if the buffer is full and the second thread blocks if the buffer is empty.

14. The computer readable medium of claim 13, wherein the buffer comprises a set of elements.

15. The computer readable medium of claim 14, wherein the buffer comprises two elements.

16. The computer readable medium of claim 14, wherein each element is one byte.

17. The computer readable medium of claim 14, wherein the data is a packet and each element is larger than the data.

18. The computer readable medium of claim 14, wherein the buffer is operable to synchronize the first thread and the second thread.

19. The computer readable medium of claim 18, wherein the buffer maintains a read pointer and a write pointer, the read pointer operable to point to an element in the set of elements and the write pointer operable to point to an element within the set of elements.

20. The computer readable medium of claim 19, wherein the first thread blocks if the read pointer and write pointer point to the same element before the read operation.

21. The computer readable medium of claim 20, wherein the second thread blocks if the write pointer and read pointer point to the same element before the render operation.

22. The computer readable medium of claim 21, wherein the first thread and second thread are synchronized with a mutex.

23. The computer readable medium of claim 21, wherein the first thread and second thread are synchronized with a Java “synchronized” function call.

24. The computer readable medium of claim 21, wherein the first thread and second thread are synchronized with a semaphore.

25. A system for a receiving and processing data, comprising:
a first thread operable to read data into a buffer;
a second thread operable to render data from the buffer; and
wherein the first thread and second thread are synchronized so that the first thread blocks if the buffer is full and the second thread blocks if the buffer is empty.

26. The system of claim 25, wherein the buffer comprises a set of elements.

27. The system of claim 26, wherein the buffer comprises two elements.

28. The system of claim 26, wherein each element is one byte.

29. The system of claim 26, wherein the data is a packet and each element is larger than the data.

30. The system of claim 26, wherein the buffer is operable to synchronize the first thread and the second thread.

31. The system of claim 30, wherein the buffer maintains a read pointer and a write pointer, the read pointer operable to point to an element in the set of elements and the write pointer operable to point to an element within the set of elements.

32. The system of claim 31, wherein the first thread blocks if the read pointer and write pointer point to the same element before the read operation.

33. The system of claim 32, wherein the second thread blocks if the write pointer and read pointer point to the same element before the render operation.

34. The system of claim 33, wherein the first thread and second thread are synchronized with a mutex.

35. The system of claim 33, wherein the first thread and second thread are synchronized with a Java “synchronized” function call.

36. The system of claim 33, wherein the first thread and second thread are synchronized with a semaphore.
